(19) United States
(12) Patent Application Publication
(10) Pub. No.: US 2021/0409992 A1
(43) Pub. Date: Dec. 30, 2021

(54) Enhancements to MDT

(71) Applicant: Telefonaktiebolaget LM Ericsson (PUBL), Stockholm (SE)

(72) Inventors: Malik Wahaj Arshad, Stockholm (SE); Wei Shen, LINKÖPING (SE); Pradeepa Ramachandra, LINKÖPING (SE); Pablo Soldati, SOLNA (SE)

(21) Appl. No.: 17/293,092

(22) PCT Filed: Dec. 18, 2019
(86) PCT No.: PCT/SE2019/051303

§ 371 Date: May 12, 2021

Related U.S. Application Data
(60) Provisional application No. 62/805,362, filed on Feb. 14, 2019.

(51) Int. Cl. H04W 24/10; H04W 76/27

(52) U.S. Cl. CPC H04W 24/10; H04W 76/27

(57) ABSTRACT

According to some embodiments, a UE receives (700) at least one Minimization of Drive Test, MDT, control and configuration parameter. The at least one MDT control and configuration parameter contains an upper bound or a lower bound or both upper and lower bounds of at least one of an allowed Logging Interval and an allowed Logging Duration. The UE determines (701) at least one MDT configuration.

### TECHNICAL FIELD

The present disclosure relates, in general, to wireless communications and, more particularly, systems and methods for enhancing Minimization of Driving Tests.

### BACKGROUND

Minimization of Driving Test (MDT) was studied in Rel-9 (TR 36.805) driven by RAN2 with the purpose to minimize actual drive tests. MDT has been introduced since Rel-10 in LTE. MDT has not been specified for New Radio (NR) in the involved standards in RAN2, RAN3 and SA5 groups.

The use cases in the TR 36.805 include:
Coverage optimization
Mobility optimization
Capacity optimization
Parameterization for common channels
QoS verification

Normal RRM mechanisms only allow for measurements to be reported when the user equipment (UE) has Radio Resource Control (RRC) connection with the particular cell, and there is sufficient uplink (UL) coverage to transport the measurement report. This may restrict measurements to be collected from UEs not experiencing radio link failure (RLF) and experiencing sufficient UL coverage. Additionally, there is no accompanying location information in normal RRM measurements.

In general, there are two types of MDT measurement logging. These include Logged MDT and Immediate MDT. According to Logged MDT, a UE in RRC_IDLE state is configured to perform periodical MDT logging after receiving the MDT configurations from the network. When the UE is in the RRC_CONNECTED state, the UE shall then report the downlink (DL) pilot strength measurements (RSRP/RSRQ) together with time information, detailed location information if available, and WLAN and/or Bluetooth information to the network using the UE information framework. The DL pilot strength measurement of Logged MDT is collected based on the existing measurements required for cell reselection purpose without requiring the UE to perform additional measurements.

Table 1 shows the measurement logging for Logged MDT

TABLE 1

| MDT | | |
|---|---|---|
| mode | RRC states | Measurement quantities |
| Logged | RRC_IDLE | RSRP and RSRQ of the serving cell and available |
| MDT | | UE measurements for intra-frequency/inter- |
| | | frequency/inter-RAT, time stamp and detailed |
| | | location information if available. |

For Logged MDT, UE receives the MDT configurations including logginginterval and loggingduration in the RRC message, i.e., LoggedMeasurementConfiguration, from the network. A timer (T330) is started at the UE upon receiving the configurations and set to loggingduration (10 min-120 min). The UE shall perform periodical MDT logging with the interval set to logginginterval (1.28 s-61.44 s) when the UE is in RRC_IDLE. FIG. 1 illustrates an example of MDT logging. The UE in RRC Connected mode receives MDT configurations and starts timer T330. The UE enters RRC_IDLE mode and starts periodic MDT logging. The UE performs MDT logging until the UE stops MDT logging (timer T330 is kept running). The UE restarts periodic MDT logging.

By contrast, measurements for Immediate MDT purposes can be performed by RAN and UE. There are a number of measurements (M1-M9) which are specified for RAN measurements and UE measurements. For UE measurements, the MDT configuration is based on the existing RRC measurement procedures for configuration and reporting with some extensions for location information.

The measurement quantities for Immediate MDT are shown in Table 2:

TABLE 2

| MDT | | |
|---|---|---|
| mode | RRC states | Measurement quantities |
| Immediate | RRC_CONNECTED | M1: RSRP and RSRQ measurement |
| MDT | | by UE. |
| | | M2: Power Headroom measurement |
| | | by UE. |
| | | M3: Received Interference Power |
| | | measurement by eNB. |
| | | M4: Data Volume measurement |
| | | separately for DL and UL, per |
| | | QCI per UE, by eNB. |
| | | M5: Scheduled IP Throughput for |
| | | MDT measurement separately for DL |
| | | and UL, per RAB per UE and per |
| | | UE for the DL, per UE for the |
| | | UL, by eNB. |
| | | M6: Packet Delay measurement, |
| | | separately for DL and UL, per QCI |
| | | per UE, see UL PDCP Delay, by the |
| | | UE, and Packet Delay in the DL per |
| | | QCI, by the eNB. |
| | | M7: Packet Loss rate measurement, |
| | | separately for DL and UL per QCI |
| | | per UE, by the eNB. |
| | | M8: RSSI measurement by UE. |
| | | M9: RTT measurement by UE. |

The reporting of the Immediate MDT is specified as follows.
For M1:
   Event-triggered measurement reports according to existing Radio Resource Management (RRM) configuration for events A1, A2, A3, A4, A5 A6, B1 or B2.
   Periodic, A2 event-triggered, or A2 event triggered periodic measurement report according to MDT specific measurement configuration.
      For M2: Reception of Power Headroom Report (PHR) according to existing RRM configuration.
      For M3-M9: End of measurement collection period.

Furthermore, Logged Multicast Broadcast Single Frequency Network (MBSFN) MDT is defined to perform measurement logging when a UE is in RRC_IDLE and RRC_CONNECTED. An enhancement on RLF is also specified for RLF report with detailed location information (e.g., GNSS) if available. RLF reports may also include available Wireless Local Area Network (WLAN) measurement results and/or Bluetooth measurement results for calculating UE location. The measurement quantities for Logged MBSFN MDT and RLF Enhancement are shown in Table 3:

TABLE 3

| MDT | | |
|---|---|---|
| mode | RRC states | Measurement quantities |
| Logged | RRC_IDLE, | RSRP, RSRQ, MBSFN RSRP, |
| MBSFN | RRC_CONNECTED | MBSFN RSRQ, BLER for |
| MDT | | signalling and BLER for |
| | | data per MCH |
| RLF | RRC_CONNECTED | RLF report with detailed |
| Enhancement | | location information (e.g., |
| | | GNSS); RLF reports may also |
| | | include available WLAN |
| | | measurement results and/or |
| | | Bluetooth measurement results |
| | | for calculating UE location. |

When MDT was introduced in Rel-10, it was decided to include MDT as a part of the Trace function which is able to provide very detailed logging data at call level. Based on the methods of activating/deactivating trace and trace configuration, the trace function can be classified into the following two aspects.
Management activation/deactivation: Trace Session is activated/deactivated in different Network Elements (NE) directly from the Element Manager (EM) using the management interfaces of those NEs.
Signalling Based Activation/Deactivation: Trace Session is activated/deactivated in different NEs using the signalling interfaces between those elements so that the NEs may forward the activation/deactivation originating from the EM.

On the other hand, the MDT can be classified as Area-based MDT and Signalling-based MDT from the use case perspective illustrated below.
Area based MDT: MDT data is collected from UEs in a specified area. The area is defined as a list of cells, which may include UMTS Terrestrial Radio Access

Network (UTRAN) or Enhanced-UTRAN (E-UTRAN), or as a list of tracking/routing/location areas. The area-based MDT is an enhancement of the management-based trace functionality. Area based MDT can be either a logged MDT or Immediate MDT.
Signalling based MDT: MDT data is collected from one specific UE. The UE that is participating in the MDT data collection is specified as International Mobile Station Equipment Identity Software Version (IMEISV) or as international mobile subscriber identity (IMSI). The signalling based MDT is an enhancement of the signalling based subscriber and equipment trace. The signalling based MDT can be either a logged MDT or Immediate MDT.

In LTE, for Area based MDT, the MDT control and configuration parameters are sent by the Network Management directly to the eNB. Then, the eNB selects UEs that fulfil the criteria, based on the area scope and the user consent, and starts the MDT. For signaling-based MDT, which may include, for example, UE specific MDT, the MDT control and configuration parameters are sent by the Network Management to MME, which then forwards the parameters to eNB associated with the specific UE.

FIG. 2 summarizes the classification of the MDT, including area-based and signaling based MDT, as described above.

With regard to location information, Logged MDT measurements are tagged by the UE with location data in the following manner:
E-UTRAN Cell Global Identifier (ECGI) or Cell-Id of the serving cell when the measurement was taken is always included.
Detailed location information (e.g. GNSS location information) is included if available in the UE when the measurement was taken. If detailed location information is available, the reporting shall consist of latitude and longitude. Depending on availability, altitude, uncertainty and confidence may be also additionally included. UE tags available detailed location information only once with upcoming measurement sample, and then the detailed location information is discarded, i.e. the validity of detailed location information is implicitly assumed to be one logging interval.

For Immediate MDT, the M1 measurements are tagged by the UE with location data in the following manner:
Detailed location information (e.g. GNSS location information) is included if available in the UE when the measurement was taken. If detailed location information is available, the reporting shall consist of latitude and longitude. Depending on availability, altitude, uncertainty and confidence may be also additionally included.
The UE should include the available detailed location information only once. If the detailed location information is obtained by GNSS positioning method, GNSS time information shall be included. For both event-based and periodic reporting, the detailed location information is included if the report is transmitted within the validity time after the detailed location information was obtained. The validity evaluation of detailed location information is left to UE implementation.

For signaling-based MDT, the Core Network (CN) shall not initiate MDT towards a particular user unless the user consent is available.

For area-based MDT, the CN indicates to the RAN whether MDT is allowed to be configured by the RAN for a user. Considerations include user consent and roaming status, as examples, by providing management-based MDT allowed information consisting of the Management Based MDT Allowed indication and, optionally, the Management Based MDT PLMN List. The management-based MDT allowed information propagates during inter-PLMN handover if the Management Based MDT PLMN List is available and includes the target PLMN.

The same user consent information can be used for area-based MDT and for signaling-based MDT. For example, there is no need to differentiate the user consent per MDT type. Collecting the user consent shall be done via customer care process. The user consent information availability shall be considered as part of the subscription data and as such this shall be provisioned to the Home Subscriber Server (HSS) database.

Certain problems exist. For example, for area-based MDT defined in the 3GPP specification, TS 32.422, the MDT configuration parameters are always generated by the Element Manager (EM) and sent to the RAN node to execute via a trace session activation request.

The MDT parameters for control and configurations can be classified as:
Control and report associated parameters:
   Job type
   Area scope where the UE measurements should be collected: list of E-UTRAN cells. Tracking Area should be converted to E-UTRAN
   Trace Reference
   IP address of Trace Collection Entity (TCE)
   Anonymization of MDT data.
   MDT PLMN List
Measurement logging associated parameters:
   List of measurements
   Reporting Trigger
   Report Interval
   Report Amount
   Event Threshold
   Logging Interval
   Logging Duration
   Measurement period LTE (if either of the measurements M4, M5 is requested)
   Collection period for RRM measurements LTE (present only if any of M2 or M3 measurements are requested).
   Positioning method

According to the specifications related to MDT, such as, for example, TS 37.320, TS 32.422 and TS 36.413, a centralized management approach is taken for the MDT control and configurations. For example, the management system supporting Operations, Administration and Maintenance (OAM) is the only entity to produce the both control and report associated parameters and Measurement logging associated parameters.

One exception is the Trace Recording Session Reference is generated by a RAN node and reported to TCE. This approach limits the usage of the MDT measurement logging since the management system or OAM system has to be aware of what values to be used to configure the parameters including the measurement logging associated parameters. However, some parameters are determined by RAN and are only known by RAN.

The following examples are provided to explain some limitations:
Rel-15 introduces a RAN-based notification area (RNA) managed by RAN for RRC_INACTIVE state. A UE in RRC_INACTIVE can be configured with Discontinuous Reception (DRX) for RAN paging by RAN (ran-PagingCycle). The ran-PagingCycle determined at RAN is not known by the OAM system. However, the parameter of the logging interval for Logged MDT is configured based on the DRX cycle.
In multi-beam operations for NR, the beam-level measurement logging is useful to map with the cell coverage, identify the weak coverage of an individual beam, or detect beam-level overshoot and interference problem. However, it is RAN instead of the management system has better knowledge on the beam level information such as the beam identifiers and the number of beams need to be considered for logging.
The approach that all of the configurations are determined by the management system does not fit the future trend of policy driven method.

### SUMMARY

Certain aspects of the present disclosure and their embodiments may provide solutions to these or other challenges.

According to certain embodiments, a method performed by a user equipment (UE) includes receiving at least one Minimization of Drive Test (MDT) control and configuration parameter. The at least one MDT control and configuration parameter contains an upper bound or a lower bound or both upper and lower bounds of at least one of an allowed Logging Interval and an allowed Logging Duration. The method further includes determining at least one MDT configuration.

According to certain embodiments, a UE includes processing circuitry configured to receive at least one MDT control and configuration parameter. The at least one MDT control and configuration parameter contains an upper bound or a lower bound or both upper and lower bounds of at least one of an allowed Logging Interval and an allowed Logging Duration. The processing circuitry is configured to determine at least one MDT configuration.

According to certain embodiments, a method performed by a base station includes receiving at least one MDT control and configuration parameter. The at least one MDT control and configuration parameter contains an upper bound or a lower bound or both upper and lower bounds of at least one of an allowed Logging Interval and an allowed Logging Duration. The method further includes determining at least one MDT configuration.

According to certain embodiments, a base station includes processing circuitry configured to receive at least one MDT control and configuration parameter. The at least one MDT control and configuration parameter contains an upper bound or a lower bound or both upper and lower bounds of at least one of an allowed Logging Interval and an allowed Logging Duration. The processing circuitry is configured to determine at least one MDT configuration.

Certain embodiments may provide one or more of the following technical advantages. For example, one technical advantage may be that certain embodiments enable RAN nodes to enhance the MDT configurations. With the proposed methods and techniques, the mechanism of MDT control and configurations is not limited to use cases where the management system has to be aware of the parameters for MDT.

As another example, a technical advantage may be that the RAN node may assist the management system to determine the logging interval and beam-level information. Furthermore, according to certain embodiments, the RAN node may determine the measurement logging associated parameters based on the received policy from an entity like Open Networking Automation Platform (ONAP).

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example of MDT logging;

FIG. 2 summarizes the classification of the MDT, including area-based and signaling based MDT;

FIG. 3 illustrates a method by a network node, according to certain embodiments;

FIG. 4 illustrates a virtual apparatus in a wireless network, according to certain embodiments;

FIG. 5 illustrates another method by a network node, which may include a base station, according to certain embodiments;

FIG. 6 illustrates another virtual apparatus in a wireless network, according to certain embodiments;

FIG. 7 illustrates a method by a wireless device, according to certain embodiments;

FIG. 8 illustrates another virtual apparatus in a wireless network, according to certain embodiments;

FIG. 9 illustrates a method by a wireless device such as a UE, according to certain embodiments;

FIG. 10 illustrates another virtual apparatus in a wireless network, according to certain embodiments;

FIG. 11 illustrates an example wireless network, according to certain embodiments;

FIG. 12 illustrates an example network node, according to certain embodiments;

FIG. 13 illustrates an example wireless device, according to certain embodiments;

FIG. 14 illustrate an example user equipment, according to certain embodiments;

FIG. 15 illustrates a virtualization environment in which functions implemented by some embodiments may be virtualized, according to certain embodiments;

FIG. 16 illustrates a telecommunication network connected via an intermediate network to a host computer, according to certain embodiments;

FIG. 17 illustrates a generalized block diagram of a host computer communicating via a base station with a user equipment over a partially wireless connection, according to certain embodiments;

FIG. 18 illustrates a method implemented in a communication system, according to one embodiment;

FIG. 19 illustrates another method implemented in a communication system, according to one embodiment;

FIG. 20 illustrates another method implemented in a communication system, according to one embodiment; and

FIG. 21 illustrates another method implemented in a communication system, according to one embodiment.

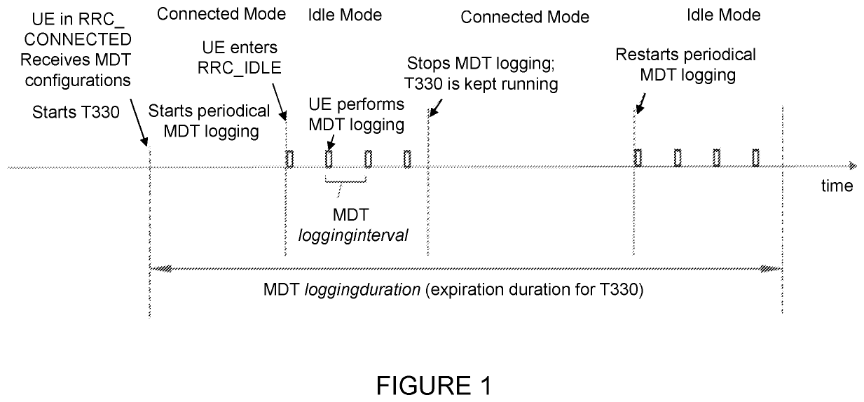

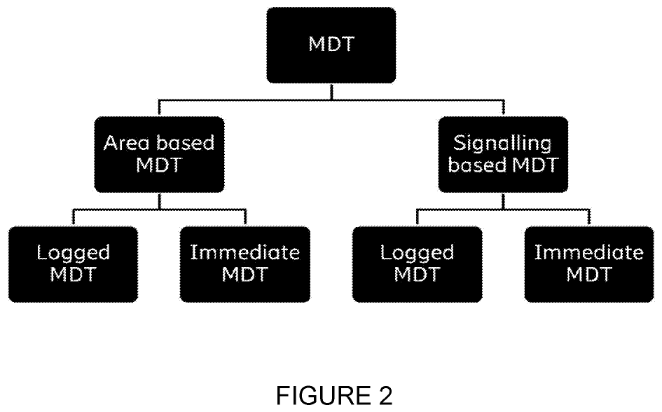

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. According to certain embodiments,

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. MSC, MME, etc), O&M, OSS, SON, positioning node (e.g. E-SMLC), MDT, test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

According to certain embodiments, the following methods are proposed to enhance the MDT configurations in RAN:
A RAN node receives the MDT control and configuration parameters including REPEAT conditions, policies for RAN to determine configurations, and upper and lower bounds of some parameters.
A RAN node determines some MDT configurations accordingly.
A RAN node repeats the MDT data collection if the REPEAT condition is configured and fulfilled.
A UE determines logging interval and logging duration according to the configured upper and lower bounds.

Certain embodiments may provide one or more of the following technical advantages. For example, one technical advantage may be that certain embodiments enable RAN nodes to enhance the MDT configurations. With the proposed methods and techniques, the mechanism of MDT control and configurations is not limited to use cases where the management system has to be aware of the parameters for MDT.

As another example, a technical advantage may be that the RAN node may assist the management system to determine the logging interval and beam-level information. Furthermore, according to certain embodiments, the RAN node may determine the measurement logging associated parameters based on the received policy from an entity like Open Networking Automation Platform (ONAP).

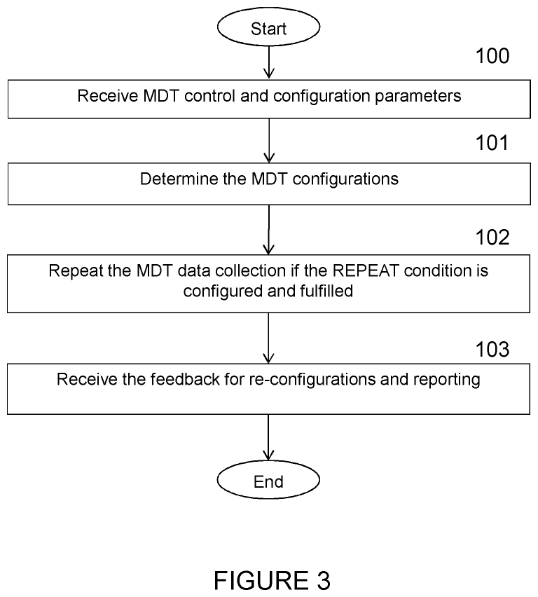

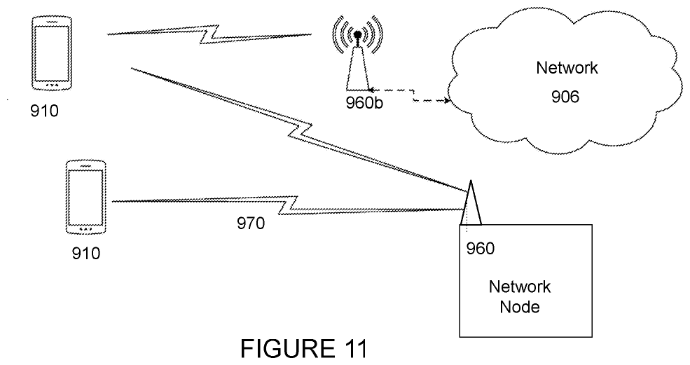

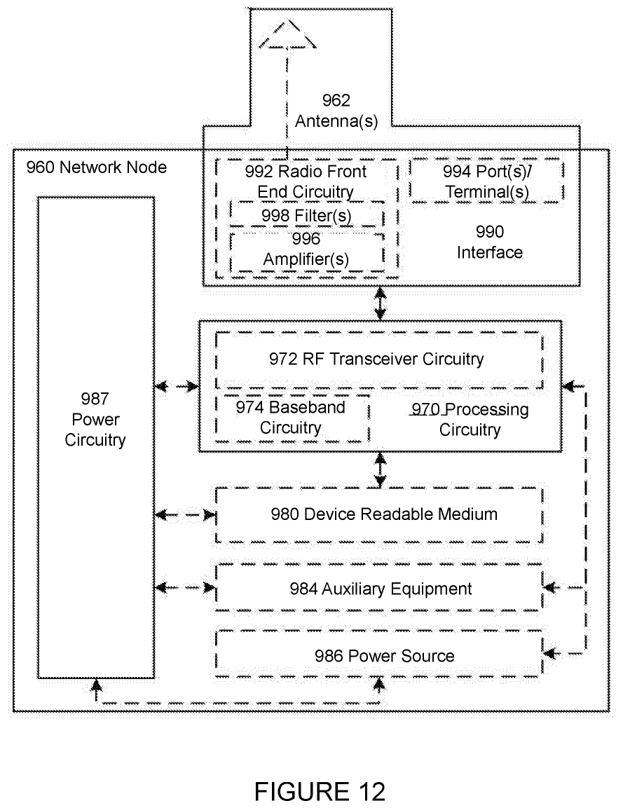

FIG. 3 illustrates a method by a network node, according to certain embodiments. A network node is described in more detail below with regard to FIGS. 11 and 12. According to certain embodiments, the network node may be a RAN node.

The method begins at step 100 when the network node receives MDT control and configuration parameters. At step 101, the network node determines the MDT configurations. At step 102, the network node repeats the MDT data collection if the REPEAT condition is configured and fulfilled. At step 103, the network node receives the feedback for re-configurations and reporting.

With regard to step 100, according to certain embodiments, a RAN node receives a Trace Session Activation request which contains MDT control and configuration parameters. According to a particular embodiment, the MDT control and configuration parameters contain one or a combination of multiple conditions (or called criteria): REPEAT condition and associated parameters such as the number of maximum allowed repetitions. For example, a timer specifying the validation duration for the REPEAT condition is included.

In another embodiment, the MDT control and configuration parameters may contain policies for a RAN node to determine the MDT configurations such as one or more parameters below but not limited to them:
List of measurements
Reporting Trigger
Report Interval
Report Amount
Event Threshold
Logging Interval
Logging Duration
Measurement period
Collection period for RRM measurements
Positioning method
Beam-level measurements

According to a particular embodiment, the policies for a RAN node to determine the MDT configurations may be contained in a dedicated message for policies.

According to a particular embodiment, the MDT control and configuration parameters may contain an upper bound or lower bound or both upper and lower bounds of the allowed Logging Interval.

According to a particular embodiment, the MDT control and configuration parameters may contain an indicator to indicate that a RAN node is allowed to determine the Logging Interval according to the upper bound or lower bound or both upper and lower bounds of the allowed Logging Interval.

According to a particular embodiment, the MDT control and configuration parameters may contain an indicator to indicate that UE is allowed to determine the Logging Interval according to the upper bound or lower bound or both upper and lower bounds of the allowed Logging Interval.

According to a particular embodiment, the MDT control and configuration parameters may contain an upper bound or lower bound or both upper and lower bounds of the allowed Logging Duration.

According to a particular embodiment, the MDT control and configuration parameters may contain an indicator to indicate that a RAN node is allowed to determine the Logging Interval according to the upper bound or lower bound or both upper and lower bounds of the allowed Logging Duration.

According to a particular embodiment, the MDT control and configuration parameters may contain an indicator to indicate that UE is allowed to determine the Logging Interval according to the upper bound or lower bound or both upper and lower bounds of the allowed Logging Duration.

According to a particular embodiment, the MDT control and configuration parameters may contain an upper bound or lower bound or both upper and lower bounds of the allowed Report Interval.

According to a particular embodiment, the MDT control and configuration parameters may contain an upper bound or lower bound or both upper and lower bounds of the allowed Report Amount.

According to a particular embodiment, the MDT control and configuration parameters may contain an upper bound or lower bound or both upper and lower bounds of the allowed Measurement Period.

According to a particular embodiment, the MDT control and configuration parameters may contain an upper bound or lower bound or both upper and lower bounds of the allowed Collection Period.

According to a particular embodiment, the MDT control and configuration parameters may contain beam related parameters for UE to measure and report. The parameters may include but are not limited to the number of beams above a threshold, a threshold, and beam identifiers.

According to a particular embodiment, the MDT control and configuration parameters may contain an upper bound or lower bound or both upper and lower bounds of the allowed number of the beams.

According to a particular embodiment, the MDT control and configuration parameters may contain an upper bound or lower bound or both upper and lower bounds of the allowed parameter related to time interval, period or amount.

According to a particular embodiment, the MDT control and configuration parameters may contain one or more than one indicator(s) to indicate whether the RAN node can determine the corresponding MDT configurations.

With regard to step 101, for area-based MDT, after receiving the MDT control and configuration parameters, the RAN node may select the suitable UEs for MDT data collection. The selection is based on the area scope received in the MDT configuration, the area where UE is located, and user consent information. If the user is not in the specified area or if the Management Based MDT Allowed IE is not present in the UE context the UE may not be selected. During UE selection, the RAN node may take into account also the UE capability (i.e. MDT capability) when it selects UE for logged MDT configuration. If the UE does not support logged MDT, the UE may not be selected.

After selecting the UEs, the RAN may determine the MDT configurations.

According to a particular embodiment, the RAN node determines the MDT configurations according to the received policies for MDT configurations. An example of a list of the MDT configurations is shown below (Note: they may not appear at the same time):
List of measurements
Reporting Trigger
Report Interval
Report Amount
Event Threshold
Logging Interval
Logging Duration
Measurement period
Collection period for RRM measurements
Positioning method

According to a particular embodiment, for Logged MDT, the RAN node may determine the logging interval according to the configured upper bound or lower bound or both upper and lower bounds of the allowed logging interval.

According to a particular embodiment, for Logged MDT, the RAN node may determine the logging duration according to the configured upper bound or lower bound or both upper and lower bounds of the allowed logging duration.

According to a particular embodiment, for Immediate MDT, the RAN node may determine the report interval according to the configured upper bound or lower bound or both upper and lower bounds of the allowed report interval.

According to a particular embodiment, for Immediate MDT, the RAN node may determine the report amount according to the configured upper bound or lower bound or both upper and lower bounds of the allowed report amount.

According to a particular embodiment, for Immediate MDT, the RAN node may determine the Measurement Period according to the configured upper bound or lower bound or both upper and lower bounds of the allowed Measurement Period.

According to a particular embodiment, for Immediate MDT, the RAN node may determine the Collection Period according to the configured upper bound or lower bound or both upper and lower bounds of the allowed Collection Period.

According to a particular embodiment, for Logged MDT, the RAN node may determine RRC state specific parameters for selected UEs in RRC_IDLE and UEs in RRC_INACTIVE, respectively.

According to a particular embodiment, the RAN node may determine beam related parameters for UE to measure and report. The parameters may include but are not limited to the number of beams above a threshold, a threshold, and beam identifiers.

With regard to step 102, where the network node, which may include a RAN node, repeats the MDT data collection if the REPEAT condition is configured and fulfilled, the RAN node may assign a trace recording session reference and start the trace recording session for MDT after selecting UEs and determining the MDT configurations if required.

According to a particular embodiment, for example, the RAN node may check if the REPEAT condition is configured and fulfilled, after collecting the MDT measurement data from UE or RAN node. If the REPEAT condition is fulfilled, the RAN node may assign a new trace recording session reference and start the trace recording session for MDT.

According to another particular embodiment, the RAN node may check if the REPEAT condition is configured and fulfilled, after collecting the MDT measurement data from UE or RAN node. If the REPEAT condition is fulfilled, the RAN node may reuse the previous assigned trace recording session reference and start the trace recording session for MDT.

With regard to step 103 where the RAN node receives the feedback for re-configurations and reporting, the ONAP or OAM may send the feedback to the RAN node after processing the measurement logging data. Thus, the RAN node may receive the feedback from the ONAP or OAM after processing the measurement logging data.

According to a particular embodiment, the feedback for re-configurations and reporting may indicate that the RAN node should perform re-configurations for MDT and a new report according to additional requirements contained in the feedback.

It is recognized that any of the above embodiments for MDT can be also applicable to the configurations for Quality of Experience (QoE), enhanced Radio Link Failure (RLF) with detailed location information, sensor related logging, and other similar measurements or logging.

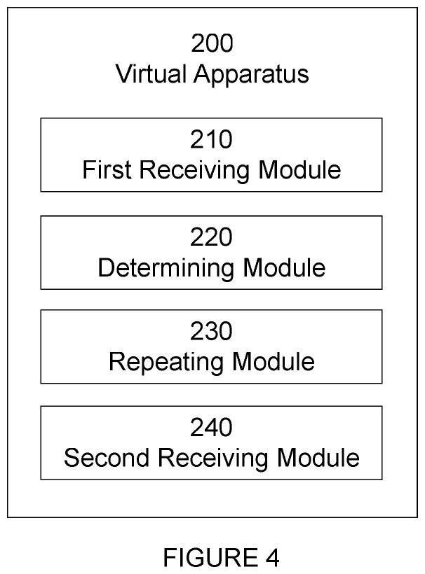

FIG. 4 illustrates a schematic block diagram of a virtual apparatus 200 in a wireless network. An example wireless network is described in more detail below with regard to FIG. 11. The apparatus may be implemented in a wireless device or network node (e.g., wireless device 910 or network node 960 shown in FIG. 11). Apparatus 200 is operable to carry out the example method described with reference to FIG. 3 and possibly any other processes or methods disclosed herein. It is also to be understood that the method of FIG. 3 is not necessarily carried out solely by apparatus 200. At least some operations of the method can be performed by one or more other entities.

Virtual Apparatus 200 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first receiving module 210, determining module 220, repeating module 230, second receiving module 240, and any other suitable units of apparatus 200 to perform corresponding functions according one or more embodiments of the present disclosure.

According to certain embodiments, first receiving module 210 may perform certain of the receiving functions of the apparatus 200. For example, first receiving module 210 may receive MDT control and configuration parameters.

According to certain embodiments, determining module 220 may perform certain of the determining functions of the apparatus 200. For example, determining module 220 may determine the MDT configurations.

According to certain embodiments, repeating module 230 may perform certain of the repeating functions of the apparatus 200. For example, repeating module 230 may repeat the MDT data collection if the REPEAT condition is configured and fulfilled.

According to certain embodiments, second receiving module 240 may perform certain of the receiving functions of the apparatus 200. For example, second receiving module 240 may receive the feedback for re-configurations and reporting.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

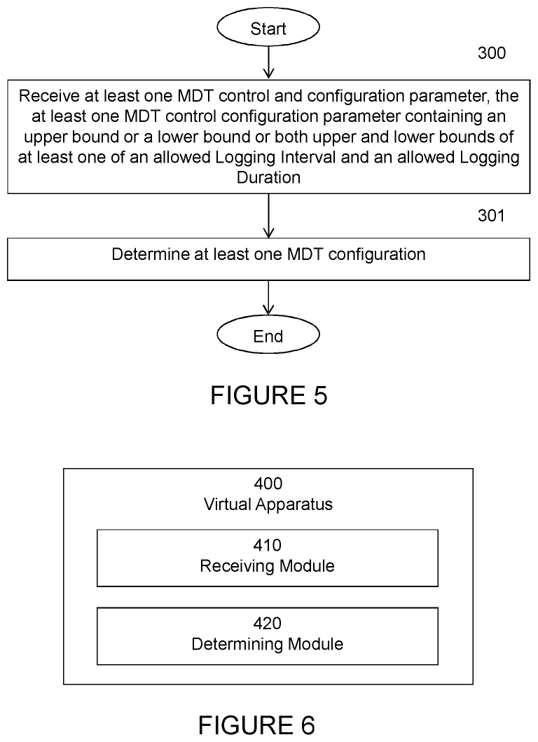

FIG. 5 illustrates another method by a network node, which may include a base station, according to certain embodiments. A network node is described in more detail below with regard to FIGS. 11 and 12.

The method begins at step 300 when base station receives at least one MDT control and configuration parameter. The at least one MDT control and configuration parameter contains an upper bound or a lower bound or both upper and lower bounds of at least one of an allowed Logging Interval and an allowed Logging Duration. At step 301, the base station determines at least one MDT configuration.

In a particular embodiment, the base station may collect MDT data from at least one UE.

In a particular embodiment, the at least one MDT control and configuration parameter may contain policies for a RAN node to determine the at least one MDT configuration.

In a particular embodiment, the at least one MDT control and configuration parameter may contain an indicator to indicate that a RAN node is allowed to determine the Logging Interval according to the upper bound or lower bound or both upper and lower bounds of the allowed Logging Interval.

In a particular embodiment, the at least one MDT control and configuration parameter may contain an indicator to indicate that a RAN node is allowed to determine the Logging Duration according to the upper bound or lower bound or both upper and lower bounds of the allowed Logging Duration.

In a particular embodiment, the base station may determine the logging interval according to the configured upper bound or lower bound or both upper and lower bounds of the allowed logging interval.

In a particular embodiment, the base station may determine the logging duration according to the configured upper bound or lower bound or both upper and lower bounds of the allowed logging duration.

FIG. 6 illustrates a schematic block diagram of another virtual apparatus 400 in a wireless network. An example wireless network is described in more detail below with regard to FIG. 11. The apparatus may be implemented in a network node, according to certain embodiments, and may be operable to carry out the example method described with reference to FIG. 5 and possibly any other processes or methods disclosed herein.

Virtual Apparatus 400 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 410, determining module 420, and any other suitable units of apparatus 400 to perform corresponding functions according one or more embodiments of the present disclosure.

According to certain embodiments, receiving module 410 may perform certain of the receiving functions of the apparatus 400. For example, receiving module 410 may receive at least one MDT control and configuration parameter. The at least one MDT control and configuration parameter may contain an upper bound or a lower bound or both upper and lower bounds of at least one of an allowed Logging Interval and an allowed Logging Duration.

According to certain embodiments, determining module 420 may perform certain of the determining functions of the apparatus 400. For example, determining module 420 may determine at least one MDT configuration.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

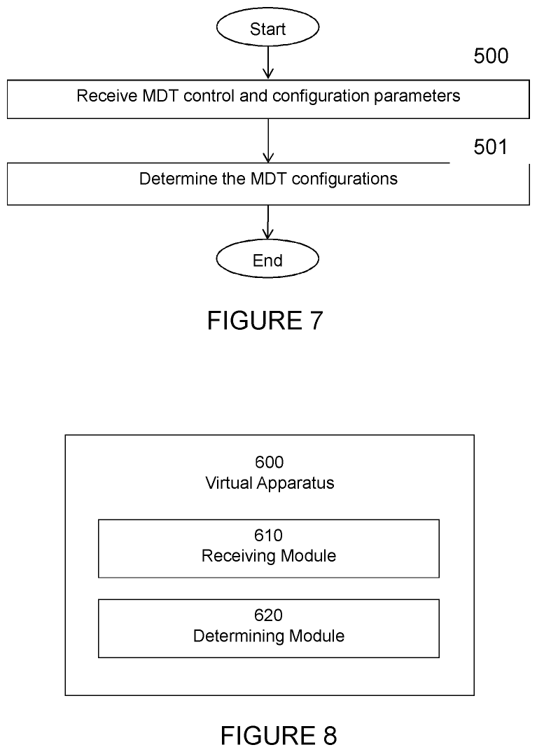

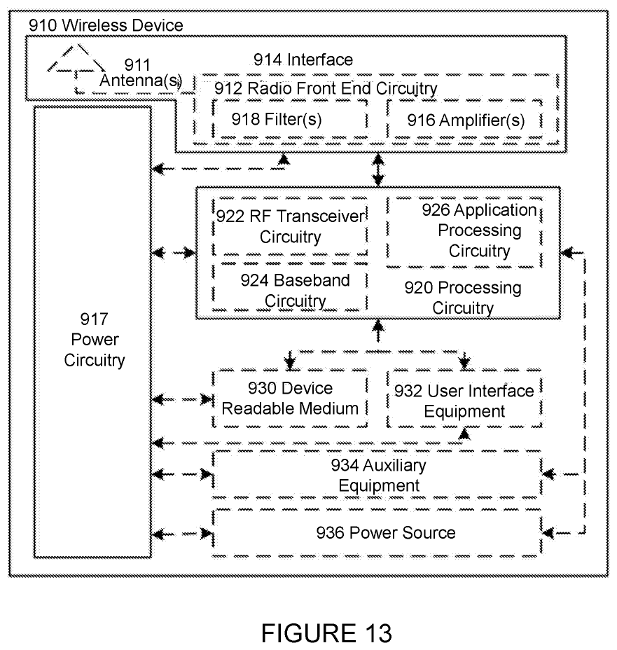

FIG. 7 illustrates a method by a wireless device, according to certain embodiments. A wireless device is described in more detail below with regard to FIGS. 11 and 13. According to certain embodiments, the wireless device may be a user equipment.

The method begins at step 500 when the wireless device receives MDT control and configuration parameters. At step 501, the wireless device determines the MDT configurations.

With regard to step 500, according to certain embodiments, for Logged MDT, the UE in RRC_IDLE or RRC_INACTIVE receives the MDT control and configuration parameters from a RAN node. In a particular embodiment, for example, the MDT control and configuration parameters may contain an upper bound or lower bound or both upper and lower bounds of the allowed Logging Interval. In another particular embodiment, the MDT control and configuration parameters may contain an upper bound or lower bound or both upper and lower bounds of the allowed Logging Duration.

With regard to step 501, where the UE determines MDT configurations, the UE may start measurement logging when it is in RRC_IDLE state or in RRC_INACTIVE state after receiving the MDT configurations.

In a particular embodiment, the UE may determine the Logging Interval according to the configured upper bound or lower bound or both upper and lower bounds of the allowed Logging Interval before starting the measurement logging.

In a particular embodiment, the UE may determine the Logging Interval according to the configured upper bound or lower bound or both upper and lower bounds of the allowed Logging Interval during the measurement logging.

In a particular embodiment, the UE may determine the Logging Duration according to the configured upper bound or lower bound or both upper and lower bounds of the allowed Logging Duration before starting the measurement logging.

In a particular embodiment, the UE may determine the Logging Duration according to the configured upper bound or lower bound or both upper and lower bounds of the allowed Logging Duration during the measurement logging.

It is recognized that any of the above embodiments for MDT can be also applicable to the configurations for Quality of Experience (QoE), enhanced Radio Link Failure (RLF) with detailed location information, sensor related logging and other similar measurements or logging.

FIG. 8 illustrates a schematic block diagram of a virtual apparatus 600 in a wireless network. An example wireless network is described in more detail below with regard to FIG. 11. The apparatus may be implemented in a wireless device or network node (e.g., wireless device 910 or network node 960 shown in FIG. 11). Apparatus 600 is operable to carry out the example method described with reference to FIG. 7 and possibly any other processes or methods disclosed herein. It is also to be understood that the method of FIG. 7 is not necessarily carried out solely by apparatus 600. At least some operations of the method can be performed by one or more other entities.

Virtual Apparatus 600 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 610, determining module 620, and any other suitable units of apparatus 600 to perform corresponding functions according one or more embodiments of the present disclosure.

According to certain embodiments, receiving module 610 may perform certain of the receiving functions of the apparatus 600. For example, receiving module 610 may receive MDT control and configuration parameters.

According to certain embodiments, determining module 620 may perform certain of the determining functions of the apparatus 600. For example, determining module 620 may determine the MDT configurations.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

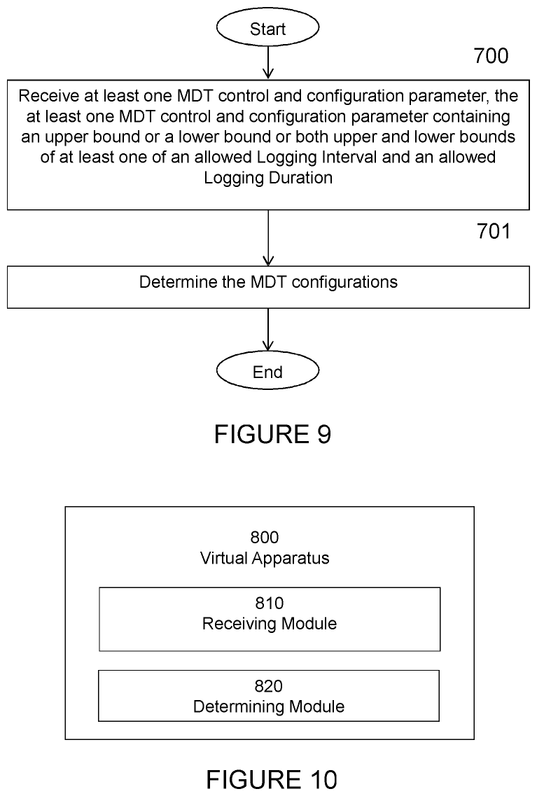

FIG. 9 illustrates a method by a wireless device such as a UE, according to certain embodiments. A wireless device and a UE are described in more detail below with regard to FIGS. 11, 13, and 14.

The method begins at step 700 when the UE receive at least one MDT control and configuration parameter. The at least one MDT control and configuration parameter contains an upper bound or a lower bound or both upper and lower bounds of at least one of an allowed Logging Interval and an allowed Logging Duration. At step 701, the UE determines at least one MDT configuration.

In a particular embodiment, the at least one MDT configuration is determined based on the at least one MDT control and configuration parameter.

In a particular embodiment, after determining the at least one MDT configuration, the UE starts measurement logging when it is in RRC_IDLE state or in RRC_INACTIVE state.

In a particular embodiment, the UE determines a Logging Interval according to the configured upper bound or lower bound or both upper and lower bounds of the allowed Logging Interval before starting the measurement logging.

In a particular embodiment, the UE determines a Logging Interval according to the configured upper bound or lower bound or both upper and lower bounds of the allowed Logging Interval during the measurement logging.

In a particular embodiment, the UE determines a Logging Duration according to the configured upper bound or lower bound or both upper and lower bounds of the allowed Logging Duration before starting the measurement logging .

In a particular embodiment, the UE determines a Logging Duration according to the configured upper bound or lower bound or both upper and lower bounds of the allowed Logging Duration during the measurement logging.

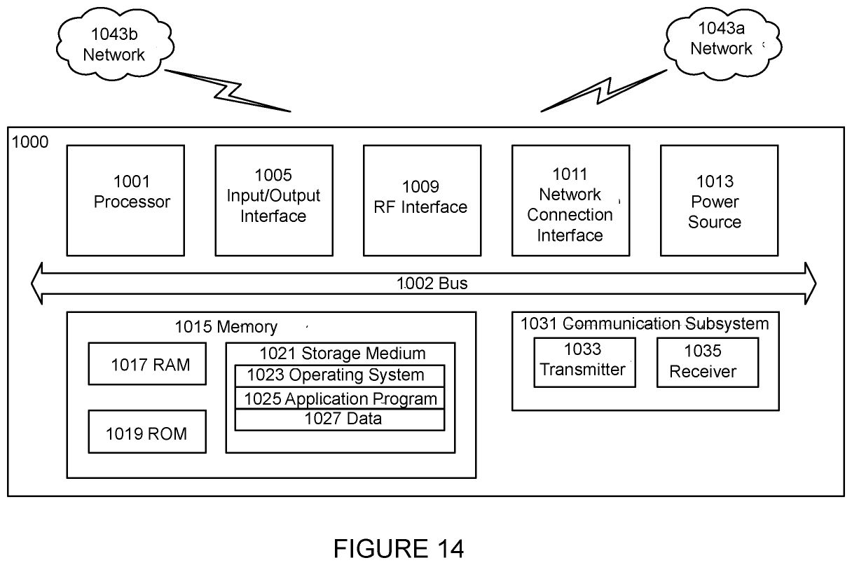

FIG. 10 illustrates a schematic block diagram of a virtual apparatus 800 in a wireless network. An example wireless network is described in more detail below with regard to FIG. 11. The apparatus may be implemented in a UE (e.g. UE 1000 shown in FIG. 14). Apparatus 800 is operable to carry out the example method described with reference to FIG. 9 and possibly any other processes or methods disclosed herein.

Virtual Apparatus 800 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 810, determining module 820, and any other suitable units of apparatus 800 to perform corresponding functions according one or more embodiments of the present disclosure.

According to certain embodiments, receiving module 810 may perform certain of the receiving functions of the apparatus 800. For example, receiving module 810 may receive at least one MDT control and configuration parameter. The at least one MDT control and configuration parameter contains an upper bound or a lower bound or both upper and lower bounds of at least one of an allowed Logging Interval and an allowed Logging Duration.

According to certain embodiments, determining module 820 may perform certain of the determining functions of the apparatus 800. For example, determining module 820 may determine at least one MDT configuration.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

FIG. 11 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 11. For simplicity, the wireless network of FIG. 11 only depicts network 906, network nodes 960 and 960b, and wireless devices 910. In practice, a wireless network may further include any additional elements suitable to support communication between wireless devices or between a wireless device and another communication device, such as a landline telephone, a service provider, or any other network node or end device. Of the illustrated components, network node 960 and wireless device 910 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 906 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 960 and wireless device 910 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

FIG. 12 illustrates an example network node, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 12, network node 960 includes processing circuitry 970, device readable medium 980, interface 990, auxiliary equipment 984, power source 986, power circuitry 987, and antenna 962. Although network node 960 illustrated in the example wireless network of FIG. 12 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 960 are depicted as single boxes located within a larger box, or nested within multiple boxes, in practice, a network node may comprise multiple different physical components that make up a single illustrated component (e.g., device readable medium 980 may comprise multiple separate hard drives as well as multiple RAM modules).

Similarly, network node 960 may be composed of multiple physically separate components (e.g., a NodeB component and a RNC component, or a BTS component and a BSC component, etc.), which may each have their own respective components. In certain scenarios in which network node 960 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 960 may be configured to support multiple radio access technologies (RATs). In such embodiments, some components may be duplicated (e.g., separate device readable medium 980 for the different RATs) and some components may be reused (e.g., the same antenna 962 may be shared by the RATs). Network node 960 may also include multiple sets of the various illustrated components for different wireless technologies integrated into network node 960, such as, for example, GSM, WCDMA, LTE, NR, WiFi, or Bluetooth wireless technologies. These wireless technologies may be integrated into the same or different chip or set of chips and other components within network node 960.

Processing circuitry 970 is configured to perform any determining, calculating, or similar operations (e.g., certain obtaining operations) described herein as being provided by a network node. These operations performed by processing circuitry 970 may include processing information obtained by processing circuitry 970 by, for example, converting the obtained information into other information, comparing the obtained information or converted information to information stored in the network node, and/or performing one or more operations based on the obtained information or converted information, and as a result of said processing making a determination.

Processing circuitry 970 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 960 components, such as device readable medium 980, network node 960 functionality. For example, processing circuitry 970 may execute instructions stored in device readable medium 980 or in memory within processing circuitry 970. Such functionality may include providing any of the various wireless features, functions, or benefits discussed herein. In some embodiments, processing circuitry 970 may include a system on a chip (SOC).

In some embodiments, processing circuitry 970 may include one or more of radio frequency (RF) transceiver circuitry 972 and baseband processing circuitry 974. In some embodiments, radio frequency (RF) transceiver circuitry 972 and baseband processing circuitry 974 may be on separate chips (or sets of chips), boards, or units, such as radio units and digital units. In alternative embodiments, part or all of RF transceiver circuitry 972 and baseband processing circuitry 974 may be on the same chip or set of chips, boards, or units.

In certain embodiments, some or all of the functionality described herein as being provided by a network node, base station, eNB or other such network device may be performed by processing circuitry 970 executing instructions stored on device readable medium 980 or memory within processing circuitry 970. In alternative embodiments, some or all of the functionality may be provided by processing circuitry 970 without executing instructions stored on a separate or discrete device readable medium, such as in a hard-wired manner. In any of those embodiments, whether executing instructions stored on a device readable storage medium or not, processing circuitry 970 can be configured to perform the described functionality. The benefits provided by such functionality are not limited to processing circuitry 970 alone or to other components of network node 960 but are enjoyed by network node 960 as a whole, and/or by end users and the wireless network generally.

Device readable medium 980 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 970. Device readable medium 980 may store any suitable instructions, data or information, including a computer program, software, an application including one or more of logic, rules, code, tables, etc. and/or other instructions capable of being executed by processing circuitry 970 and, utilized by network node 960. Device readable medium 980 may be used to store any calculations made by processing circuitry 970 and/or any data received via interface 990. In some embodiments, processing circuitry 970 and device readable medium 980 may be considered to be integrated.

Interface 990 is used in the wired or wireless communication of signalling and/or data between network node 960, network 906, and/or WDs 910. As illustrated, interface 990 comprises port(s)/terminal(s) 994 to send and receive data, for example to and from network 906 over a wired connection. Interface 990 also includes radio front end circuitry 992 that may be coupled to, or in certain embodiments a part of, antenna 962. Radio front end circuitry 992 comprises filters 998 and amplifiers 996. Radio front end circuitry 992 may be connected to antenna 962 and processing circuitry 970. Radio front end circuitry may be configured to condition signals communicated between antenna 962 and processing circuitry 970. Radio front end circuitry 992 may receive digital data that is to be sent out to other network nodes or WDs via a wireless connection. Radio front end circuitry 992 may convert the digital data into a radio signal having the appropriate channel and bandwidth parameters using a combination of filters 998 and/or amplifiers 996. The radio signal may then be transmitted via antenna 962. Similarly, when receiving data, antenna 962 may collect radio signals which are then converted into digital data by radio front end circuitry 992. The digital data may be passed to processing circuitry 970. In other embodiments, the interface may comprise different components and/or different combinations of components.

In certain alternative embodiments, network node 960 may not include separate radio front end circuitry 992, instead, processing circuitry 970 may comprise radio front end circuitry and may be connected to antenna 962 without separate radio front end circuitry 992. Similarly, in some embodiments, all or some of RF transceiver circuitry 972 may be considered a part of interface 990. In still other embodiments, interface 990 may include one or more ports or terminals 994, radio front end circuitry 992, and RF transceiver circuitry 972, as part of a radio unit (not shown), and interface 990 may communicate with baseband processing circuitry 974, which is part of a digital unit (not shown).

Antenna 962 may include one or more antennas, or antenna arrays, configured to send and/or receive wireless signals. Antenna 962 may be coupled to radio front end circuitry 990 and may be any type of antenna capable of transmitting and receiving data and/or signals wirelessly. In some embodiments, antenna 962 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 962 may be separate from network node 960 and may be connectable to network node 960 through an interface or port.

Antenna 962, interface 990, and/or processing circuitry 970 may be configured to perform any receiving operations and/or certain obtaining operations described herein as being performed by a network node. Any information, data and/or signals may be received from a wireless device, another network node and/or any other network equipment. Similarly, antenna 962, interface 990, and/or processing circuitry 970 may be configured to perform any transmitting operations described herein as being performed by a network node. Any information, data and/or signals may be transmitted to a wireless device, another network node and/or any other network equipment.

Power circuitry 987 may comprise, or be coupled to, power management circuitry and is configured to supply the components of network node 960 with power for performing the functionality described herein. Power circuitry 987 may receive power from power source 986. Power source 986 and/or power circuitry 987 may be configured to provide power to the various components of network node 960 in a form suitable for the respective components (e.g., at a voltage and current level needed for each respective component). Power source 986 may either be included in, or external to, power circuitry 987 and/or network node 960. For example, network node 960 may be connectable to an external power source (e.g., an electricity outlet) via an input circuitry or interface such as an electrical cable, whereby the external power source supplies power to power circuitry 987. As a further example, power source 986 may comprise a source of power in the form of a battery or battery pack which is connected to, or integrated in, power circuitry 987. The battery may provide backup power should the external power source fail. Other types of power sources, such as photovoltaic devices, may also be used.

Alternative embodiments of network node 960 may include additional components beyond those shown in FIG. 12 that may be responsible for providing certain aspects of the network node's functionality, including any of the functionality described herein and/or any functionality necessary to support the subject matter described herein. For example, network node 960 may include user interface equipment to allow input of information into network node 960 and to allow output of information from network node 960. This may allow a user to perform diagnostic, maintenance, repair, and other administrative functions for network node 960.

FIG. 13 illustrates an example wireless device according to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless devices include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 910 includes antenna 911, interface 914, processing circuitry 920, device readable medium 930, user interface equipment 932, auxiliary equipment 934, power source 936 and power circuitry 937. Wireless device 910 may include multiple sets of one or more of the illustrated components for different wireless technologies supported by wireless device 910, such as, for example, GSM, WCDMA, LTE, NR, WiFi, WiMAX, or Bluetooth wireless technologies, just to mention a few. These wireless technologies may be integrated into the same or different chips or set of chips as other components within wireless device 910.

Antenna 911 may include one or more antennas or antenna arrays, configured to send and/or receive wireless signals, and is connected to interface 914. In certain alternative embodiments, antenna 911 may be separate from wireless device 910 and be connectable to wireless device 910 through an interface or port. Antenna 911, interface 914, and/or processing circuitry 920 may be configured to perform any receiving or transmitting operations described herein as being performed by a wireless device. Any information, data and/or signals may be received from a network node and/or another wireless device. In some embodiments, radio front end circuitry and/or antenna 911 may be considered an interface.

As illustrated, interface 914 comprises radio front end circuitry 912 and antenna 911. Radio front end circuitry 912 comprise one or more filters 918 and amplifiers 916. Radio front end circuitry 914 is connected to antenna 911 and processing circuitry 920 and is configured to condition signals communicated between antenna 911 and processing circuitry 920. Radio front end circuitry 912 may be coupled to or a part of antenna 911. In some embodiments, wireless device 910 may not include separate radio front end circuitry 912; rather, processing circuitry 920 may comprise radio front end circuitry and may be connected to antenna 911. Similarly, in some embodiments, some or all of RF transceiver circuitry 922 may be considered a part of interface 914. Radio front end circuitry 912 may receive digital data that is to be sent out to other network nodes or wireless devices via a wireless connection. Radio front end circuitry 912 may convert the digital data into a radio signal having the appropriate channel and bandwidth parameters using a combination of filters 918 and/or amplifiers 916. The radio signal may then be transmitted via antenna 911. Similarly, when receiving data, antenna 911 may collect radio signals which are then converted into digital data by radio front end circuitry 912. The digital data may be passed to processing circuitry 920. In other embodiments, the interface may comprise different components and/or different combinations of components.

Processing circuitry 920 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 910 components, such as device readable medium 930, wireless device 910 functionality. Such functionality may include providing any of the various wireless features or benefits discussed herein. For example, processing circuitry 920 may execute instructions stored in device readable medium 930 or in memory within processing circuitry 920 to provide the functionality disclosed herein.

As illustrated, processing circuitry 920 includes one or more of RF transceiver circuitry 922, baseband processing circuitry 924, and application processing circuitry 926. In other embodiments, the processing circuitry may comprise different components and/or different combinations of components. In certain embodiments processing circuitry 920 of wireless device 910 may comprise a SOC. In some embodiments, RF transceiver circuitry 922, baseband processing circuitry 924, and application processing circuitry 926 may be on separate chips or sets of chips. In alternative embodiments, part or all of baseband processing circuitry 924 and application processing circuitry 926 may be combined into one chip or set of chips, and RF transceiver circuitry 922 may be on a separate chip or set of chips. In still alternative embodiments, part or all of RF transceiver circuitry 922 and baseband processing circuitry 924 may be on the same chip or set of chips, and application processing circuitry 926 may be on a separate chip or set of chips. In yet other alternative embodiments, part or all of RF transceiver circuitry 922, baseband processing circuitry 924, and application processing circuitry 926 may be combined in the same chip or set of chips. In some embodiments, RF transceiver circuitry 922 may be a part of interface 914. RF transceiver circuitry 922 may condition RF signals for processing circuitry 920.

In certain embodiments, some or all of the functionality described herein as being performed by a wireless device may be provided by processing circuitry 920 executing instructions stored on device readable medium 930, which in certain embodiments may be a computer-readable storage medium. In alternative embodiments, some or all of the functionality may be provided by processing circuitry 920 without executing instructions stored on a separate or discrete device readable storage medium, such as in a hard-wired manner. In any of those particular embodiments, whether executing instructions stored on a device readable storage medium or not, processing circuitry 920 can be configured to perform the described functionality. The benefits provided by such functionality are not limited to processing circuitry 920 alone or to other components of wireless device 910 but are enjoyed by wireless device 910 as a whole, and/or by end users and the wireless network generally.

Processing circuitry 920 may be configured to perform any determining, calculating, or similar operations (e.g., certain obtaining operations) described herein as being performed by a wireless device. These operations, as performed by processing circuitry 920, may include processing information obtained by processing circuitry 920 by, for example, converting the obtained information into other information, comparing the obtained information or converted information to information stored by wireless device 910, and/or performing one or more operations based on the obtained information or converted information, and as a result of said processing making a determination.

Device readable medium 930 may be operable to store a computer program, software, an application including one or more of logic, rules, code, tables, etc. and/or other instructions capable of being executed by processing circuitry 920. Device readable medium 930 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 920. In some embodiments, processing circuitry 920 and device readable medium 930 may be considered to be integrated.

User interface equipment 932 may provide components that allow for a human user to interact with wireless device 910. Such interaction may be of many forms, such as visual, audial, tactile, etc. User interface equipment 932 may be operable to produce output to the user and to allow the user to provide input to wireless device 910. The type of interaction may vary depending on the type of user interface equipment 932 installed in wireless device 910. For example, if wireless device 910 is a smart phone, the interaction may be via a touch screen; if wireless device 910 is a smart meter, the interaction may be through a screen that provides usage (e.g., the number of gallons used) or a speaker that provides an audible alert (e.g., if smoke is detected). User interface equipment 932 may include input interfaces, devices and circuits, and output interfaces, devices and circuits. User interface equipment 932 is configured to allow input of information into wireless device 910 and is connected to processing circuitry 920 to allow processing circuitry 920 to process the input information. User interface equipment 932 may include, for example, a microphone, a proximity or other sensor, keys/buttons, a touch display, one or more cameras, a USB port, or other input circuitry. User interface equipment 932 is also configured to allow output of information from wireless device 910, and to allow processing circuitry 920 to output information from wireless device 910. User interface equipment 932 may include, for example, a speaker, a display, vibrating circuitry, a USB port, a headphone interface, or other output circuitry. Using one or more input and output interfaces, devices, and circuits, of user interface equipment 932, wireless device 910 may communicate with end users and/or the wireless network and allow them to benefit from the functionality described herein.

Auxiliary equipment 934 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 934 may vary depending on the embodiment and/or scenario.

Power source 936 may, in some embodiments, be in the form of a battery or battery pack. Other types of power sources, such as an external power source (e.g., an electricity outlet), photovoltaic devices or power cells, may also be used. wireless device 910 may further comprise power circuitry 937 for delivering power from power source 936 to the various parts of wireless device 910 which need power from power source 936 to carry out any functionality described or indicated herein. Power circuitry 937 may in certain embodiments comprise power management circuitry. Power circuitry 937 may additionally or alternatively be operable to receive power from an external power source; in which case wireless device 910 may be connectable to the external power source (such as an electricity outlet) via input circuitry or an interface such as an electrical power cable. Power circuitry 937 may also in certain embodiments be operable to deliver power from an external power source to power source 936. This may be, for example, for the charging of power source 936. Power circuitry 937 may perform any formatting, converting, or other modification to the power from power source 936 to make the power suitable for the respective components of wireless device 910 to which power is supplied.

FIG. 14 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1000 may be any UE identified by the 3^{rd} Generation Partnership Project (3GPP), including a NB-IoT UE, a machine type communication (MTC) UE, and/or an enhanced MTC (eMTC) UE. UE 1000, as illustrated in FIG. 14, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 14 is a UE, the components discussed herein are equally applicable to a wireless device, and vice-versa.

In FIG. 14, UE 1000 includes processing circuitry 1001 that is operatively coupled to input/output interface 1005, radio frequency (RF) interface 1009, network connection interface 1011, memory 1015 including random access memory (RAM) 1017, read-only memory (ROM) 1019, and storage medium 1021 or the like, communication subsystem 1031, power source 1033, and/or any other component, or any combination thereof. Storage medium 1021 includes operating system 1023, application program 1025, and data 1027. In other embodiments, storage medium 1021 may include other similar types of information. Certain UEs may utilize all of the components shown in FIG. 14, or only a subset of the components. The level of integration between the components may vary from one UE to another UE. Further, certain UEs may contain multiple instances of a component, such as multiple processors, memories, transceivers, transmitters, receivers, etc.

In FIG. 14, processing circuitry 1001 may be configured to process computer instructions and data. Processing circuitry 1001 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1001 may include two central processing units (CPUs). Data may be information in a form suitable for use by a computer.

In the depicted embodiment, input/output interface 1005 may be configured to provide a communication interface to an input device, output device, or input and output device. UE 1000 may be configured to use an output device via input/output interface 1005. An output device may use the same type of interface port as an input device. For example, a USB port may be used to provide input to and output from UE 1000. The output device may be a speaker, a sound card, a video card, a display, a monitor, a printer, an actuator, an emitter, a smartcard, another output device, or any combination thereof. UE 1000 may be configured to use an input device via input/output interface 1005 to allow a user to capture information into UE 1000. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 14, RF interface 1009 may be configured to provide a communication interface to RF components such as a transmitter, a receiver, and an antenna. Network connection interface 1011 may be configured to provide a communication interface to network 1043a. Network 1043a may encompass wired and/or wireless networks such as a local-area network (LAN), a wide-area network (WAN), a computer network, a wireless network, a telecommunications network, another like network or any combination thereof. For example, network 1043a may comprise a Wi-Fi network. Network connection interface 1011 may be configured to include a receiver and a transmitter interface used to communicate with one or more other devices over a communication network according to one or more communication protocols, such as Ethernet, TCP/IP, SONET, ATM, or the like. Network connection interface 1011 may implement receiver and transmitter functionality appropriate to the communication network links (e.g., optical, electrical, and the like). The transmitter and receiver functions may share circuit components, software or firmware, or alternatively may be implemented separately.

RAM 1017 may be configured to interface via bus 1002 to processing circuitry 1001 to provide storage or caching of data or computer instructions during the execution of software programs such as the operating system, application programs, and device drivers. ROM 1019 may be configured to provide computer instructions or data to processing circuitry 1001. For example, ROM 1019 may be configured to store invariant low-level system code or data for basic system functions such as basic input and output (I/O), startup, or reception of keystrokes from a keyboard that are stored in a non-volatile memory. Storage medium 1021 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1021 may be configured to include operating system 1023, application program 1025 such as a web browser application, a widget or gadget engine or another application, and data file 1027. Storage medium 1021 may store, for use by UE 1000, any of a variety of various operating systems or combinations of operating systems.

Storage medium 1021 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1021 may allow UE 1000 to access computer-executable instructions, application programs or the like, stored on transitory or non-transitory memory media, to off-load data, or to upload data. An article of manufacture, such as one utilizing a communication system may be tangibly embodied in storage medium 1021, which may comprise a device readable medium.

In FIG. 14, processing circuitry 1001 may be configured to communicate with network 1043b using communication subsystem 1031. Network 1043a and network 1043b may be the same network or networks or different network or networks. Communication subsystem 1031 may be configured to include one or more transceivers used to communicate with network 1043b. For example, communication subsystem 1031 may be configured to include one or more transceivers used to communicate with one or more remote transceivers of another device capable of wireless communication such as another wireless device, UE, or base station of a radio access network (RAN) according to one or more communication protocols, such as IEEE 802, CDMA, WCDMA, GSM, LTE, UTRAN, WiMax, or the like. Each transceiver may include transmitter 1033 and/or receiver 1035 to implement transmitter or receiver functionality, respectively, appropriate to the RAN links (e.g., frequency allocations and the like). Further, transmitter 1033 and receiver 1035 of each transceiver may share circuit components, software or firmware, or alternatively may be implemented separately.

In the illustrated embodiment, the communication functions of communication subsystem 1031 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1031 may include cellular communication, Wi-Fi communication, Bluetooth communication, and GPS communication. Network 1043b may encompass wired and/or wireless networks such as a local-area network (LAN), a wide-area network (WAN), a computer network, a wireless network, a telecommunications network, another like network or any combination thereof. For example, network 1043b may be a cellular network, a Wi-Fi network, and/or a near-field network. Power source 1013 may be configured to provide alternating current (AC) or direct current (DC) power to components of UE 1000.

The features, benefits and/or functions described herein may be implemented in one of the components of UE 1000 or partitioned across multiple components of UE 1000. Further, the features, benefits, and/or functions described herein may be implemented in any combination of hardware, software or firmware. In one example, communication subsystem 1031 may be configured to include any of the components described herein. Further, processing circuitry 1001 may be configured to communicate with any of such components over bus 1002. In another example, any of such components may be represented by program instructions stored in memory that when executed by processing circuitry 1001 perform the corresponding functions described herein. In another example, the functionality of any of such components may be partitioned between processing circuitry 1001 and communication subsystem 1031. In another example, the non-computationally intensive functions of any of such components may be implemented in software or firmware and the computationally intensive functions may be implemented in hardware.

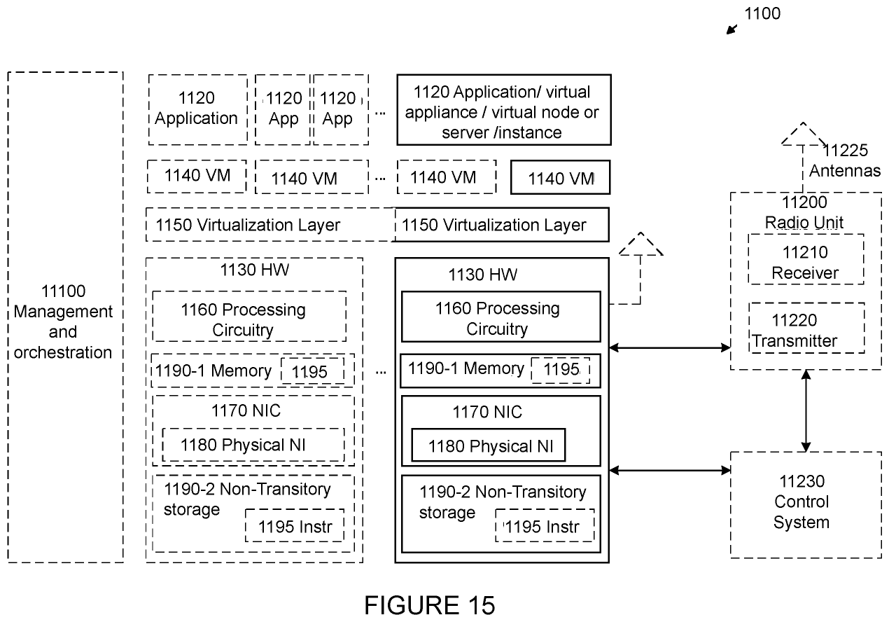

FIG. 15 is a schematic block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1100 hosted by one or more of hardware nodes 1130. Further, in embodiments in which the virtual node is not a radio access node or does not require radio connectivity (e.g., a core network node), then the network node may be entirely virtualized.

The functions may be implemented by one or more applications 1120 (which may alternatively be called software instances, virtual appliances, network functions, virtual nodes, virtual network functions, etc.) operative to implement some of the features, functions, and/or benefits of some of the embodiments disclosed herein. Applications 1120 are run in virtualization environment 1100 which provides hardware 1130 comprising processing circuitry 1160 and memory 1190. Memory 1190 contains instructions 1195 executable by processing circuitry 1160 whereby application 1120 is operative to provide one or more of the features, benefits, and/or functions disclosed herein.

Virtualization environment 1100, comprises general-purpose or special-purpose network hardware devices 1130 comprising a set of one or more processors or processing circuitry 1160, which may be commercial off-the-shelf (COTS) processors, dedicated Application Specific Integrated Circuits (ASICs), or any other type of processing circuitry including digital or analog hardware components or special purpose processors. Each hardware device may comprise memory 1190-1 which may be non-persistent memory for temporarily storing instructions 1195 or software executed by processing circuitry 1160. Each hardware device may comprise one or more network interface controllers (NICs) 1170, also known as network interface cards, which include physical network interface 1180. Each hardware device may also include non-transitory, persistent, machine-readable storage media 1190-2 having stored therein software 1195 and/or instructions executable by processing circuitry 1160. Software 1195 may include any type of software including software for instantiating one or more virtualization layers 1150 (also referred to as hypervisors), software to execute virtual machines 1140 as well as software allowing it to execute functions, features and/or benefits described in relation with some embodiments described herein.

Virtual machines 1140, comprise virtual processing, virtual memory, virtual networking or interface and virtual storage, and may be run by a corresponding virtualization layer 1150 or hypervisor. Different embodiments of the instance of virtual appliance 1120 may be implemented on one or more of virtual machines 1140, and the implementations may be made in different ways.

During operation, processing circuitry 1160 executes software 1195 to instantiate the hypervisor or virtualization layer 1150, which may sometimes be referred to as a virtual machine monitor (VMM). Virtualization layer 1150 may present a virtual operating platform that appears like networking hardware to virtual machine 1140.

As shown in FIG. 15, hardware 1130 may be a standalone network node with generic or specific components. Hardware 1130 may comprise antenna 11225 and may implement some functions via virtualization. Alternatively, hardware 1130 may be part of a larger cluster of hardware (e.g. such as in a data center or customer premise equipment (CPE)) where many hardware nodes work together and are managed via management and orchestration (MANO) 11100, which, among others, oversees lifecycle management of applications 1120.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1140 may be a software implementation of a physical machine that runs programs as if they were executing on a physical, non-virtualized machine. Each of virtual machines 1140, and that part of hardware 1130 that executes that virtual machine, be it hardware dedicated to that virtual machine and/or hardware shared by that virtual machine with others of the virtual machines 1140, forms a separate virtual network elements (VNE).

Still in the context of NFV, Virtual Network Function (VNF) is responsible for handling specific network functions that run in one or more virtual machines 1140 on top of hardware networking infrastructure 1130 and corresponds to application 1120 in FIG. 15.

In some embodiments, one or more radio units 11200 that each include one or more transmitters 11220 and one or more receivers 11210 may be coupled to one or more antennas 11225. Radio units 11200 may communicate directly with hardware nodes 1130 via one or more appropriate network interfaces and may be used in combination with the virtual components to provide a virtual node with radio capabilities, such as a radio access node or a base station.

In some embodiments, some signaling can be affected with the use of control system 11230 which may alternatively be used for communication between the hardware nodes 1130 and radio units 11200.

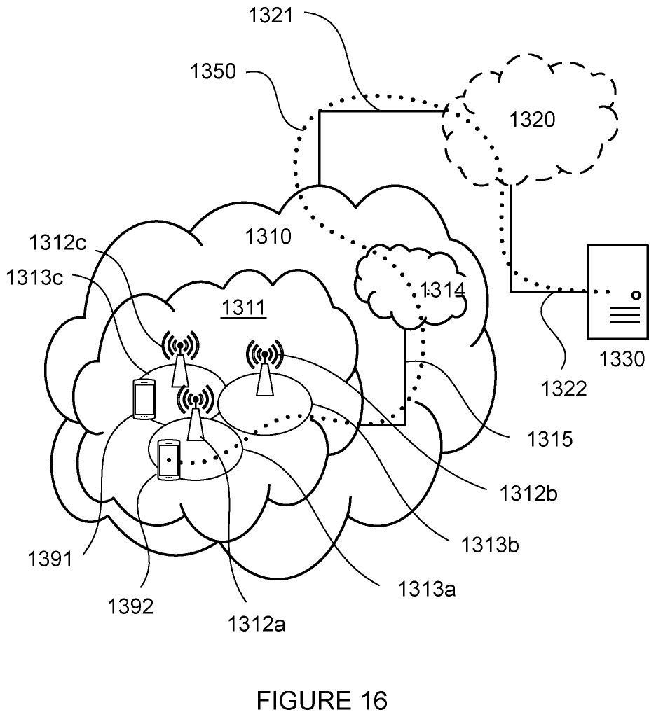

FIG. 16 illustrates a telecommunication network connected via an intermediate network to a host computer in accordance with some embodiments.

With reference to FIG. 16, in accordance with an embodiment, a communication system includes telecommunication network 1310, such as a 3GPP-type cellular network, which comprises access network 1311, such as a radio access network, and core network 1314. Access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A first UE 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312.

Telecommunication network 1310 is itself connected to host computer 1330, which may be embodied in the hardware and/or software of a standalone server, a cloud-implemented server, a distributed server or as processing resources in a server farm. Host computer 1330 may be under the ownership or control of a service provider or may be operated by the service provider or on behalf of the service provider. Connections 1321 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private or hosted network; intermediate network 1320, if any, may be a backbone network or the Internet; in particular, intermediate network 1320 may comprise two or more sub-networks (not shown).

The communication system of FIG. 16 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signaling via OTT connection 1350, using access network 1311, core network 1314, any intermediate network 1320 and possible further infrastructure (not shown) as intermediaries. OTT connection 1350 may be transparent in the sense that the participating communication devices through which OTT connection 1350 passes are unaware of routing of uplink and downlink communications. For example, base station 1312 may not or need not be informed about the past routing of an incoming downlink communication with data originating from host computer 1330 to be forwarded (e.g., handed over) to a connected UE 1391. Similarly, base station 1312 need not be aware of the future routing of an outgoing uplink communication originating from the UE 1391 towards the host computer 1330.

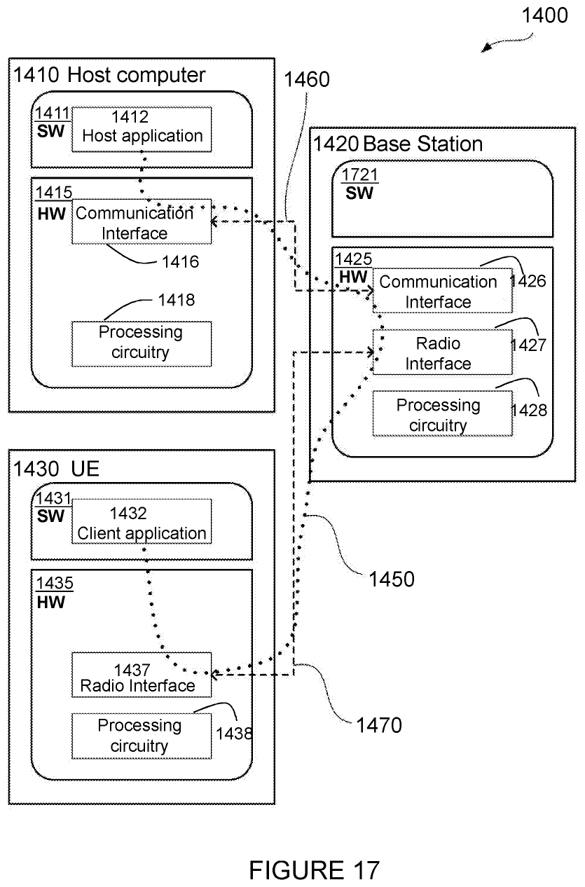

FIG. 17 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 17. In communication system 1400, host computer 1410 comprises hardware 1415 including communication interface 1416 configured to set up and maintain a wired or wireless connection with an interface of a different communication device of communication system 1400. Host computer 1410 further comprises processing circuitry 1418, which may have storage and/or processing capabilities. In particular, processing circuitry 1418 may comprise one or more programmable processors, application-specific integrated circuits, field programmable gate arrays or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with UE 1430 located in a coverage area (not shown in FIG. 17) served by base station 1420. Communication interface 1426 may be configured to facilitate connection 1460 to host computer 1410. Connection 1460 may be direct or it may pass through a core network (not shown in FIG. 17) of the telecommunication system and/or through one or more intermediate networks outside the telecommunication system. In the embodiment shown, hardware 1425 of base station 1420 further includes processing circuitry 1428, which may comprise one or more programmable processors, application-specific integrated circuits, field programmable gate arrays or combinations of these (not shown) adapted to execute instructions. Base station 1420 further has software 1421 stored internally or accessible via an external connection.

Communication system 1400 further includes UE 1430 already referred to. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, application-specific integrated circuits, field programmable gate arrays or combinations of these (not shown) adapted to execute instructions. UE 1430 further comprises software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 17 may be similar or identical to host computer 1330, one of base stations 1312a, 1312b, 1312c and one of UEs 1391, 1392 of FIG. 16, respectively. This is to say, the inner workings of these entities may be as shown in FIG. 17 and independently, the surrounding network topology may be that of FIG. 16.

In FIG. 17, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further take decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In embodiments, sensors (not shown) may be deployed in or in association with communication devices through which OTT connection 1450 passes; the sensors may participate in the measurement procedure by supplying values of the monitored quantities exemplified above or supplying values of other physical quantities from which software 1411, 1431 may compute or estimate the monitored quantities. The reconfiguring of OTT connection 1450 may include message format, retransmission settings, preferred routing etc.; the reconfiguring need not affect base station 1420, and it may be unknown or imperceptible to base station 1420. Such procedures and functionalities may be known and practiced in the art. In certain embodiments, measurements may involve proprietary UE signaling facilitating host computer 1410's measurements of throughput, propagation times, latency and the like. The measurements may be implemented in that software 1411 and 1431 causes messages to be transmitted, in particular empty or ‘dummy’ messages, using OTT connection 1450 while it monitors propagation times, errors etc.

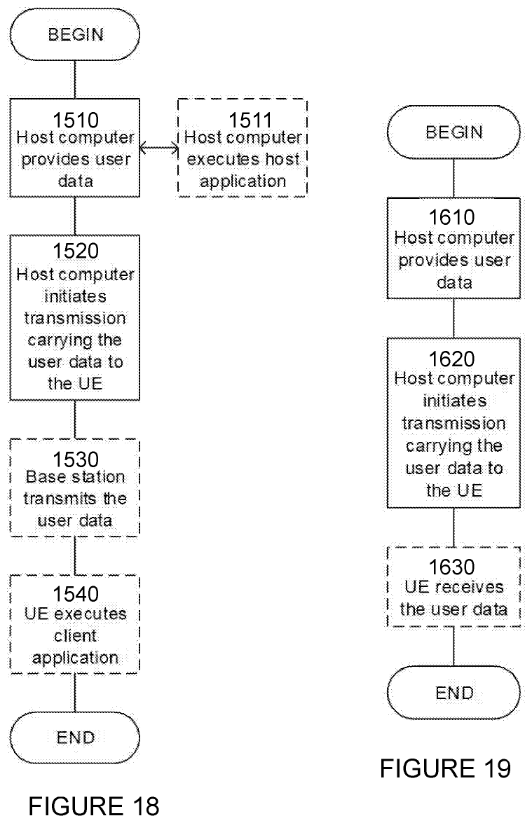

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

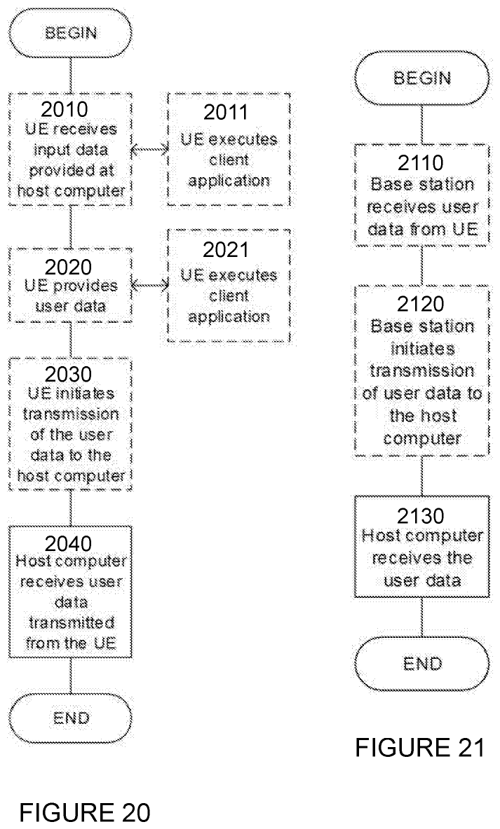

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In step 2010 (which may be optional), the UE receives input data provided by the host computer. Additionally or alternatively, in step 2020, the UE provides user data. In substep 2021 (which may be optional) of step 2020, the UE provides the user data by executing a client application. In substep 2011 (which may be optional) of step 2010, the UE executes a client application which provides the user data in reaction to the received input data provided by the host computer. In providing the user data, the executed client application may further consider user input received from the user. Regardless of the specific manner in which the user data was provided, the UE initiates, in substep 2030 (which may be optional), transmission of the user data to the host computer. In step 2040 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In step 2110 (which may be optional), in accordance with the teachings of the embodiments described throughout this disclosure, the base station receives user data from the UE. In step 2120 (which may be optional), the base station initiates transmission of the received user data to the host computer. In step 2130 (which may be optional), the host computer receives the user data carried in the transmission initiated by the base station.

Some example embodiments are discussed below.

Group A Embodiments

1. A method performed by a UE, the method comprising:
receiving at least one MDT control and configuration parameter; and
determine at least one MDT configuration.

2. The method of Embodiment 1, wherein the at least one MDT configuration is determined based on the at least one MDT control and configuration parameter.

3. The method of any one of Embodiments 1 to 2, wherein the UE is in RRC_IDLE or RRC_INACTIVE mode and the UE receives the at least one MDT control and configuration parameter from a RAN node.

4. The method of any one of Embodiments 1 to 3, wherein the MDT control and configuration parameters contain an upper bound or lower bound or both upper and lower bounds of an allowed Logging Interval.

5. The method of any one of Embodiments 1 to 4, wherein the MDT control and configuration parameters contain an upper bound or lower bound or both upper and lower bounds of an allowed Logging Duration.

6. The method of Embodiments 1 to 5, wherein after determining the at least one MDT configuration, the UE starts measurement logging when it is in RRC_IDLE state or in RRC_INACTIVE state.

7. The method of Embodiments 4 and 6, further comprising determining a Logging Interval according to the configured upper bound or lower bound or both upper and lower bounds of the allowed Logging Interval before starting the measurement logging.

8. The method of Embodiments 4 and 6, further comprising determining a Logging Interval according to the configured upper bound or lower bound or both upper and lower bounds of the allowed Logging Interval during the measurement logging.

9. The method of Embodiments 5 and 6, further comprising determining a Logging Duration according to the configured upper bound or lower bound or both upper and lower bounds of the allowed Logging Duration before starting the measurement logging.

10. The method of Embodiments 5 and 6, further comprising determining a Logging Duration according to the configured upper bound or lower bound or both upper and lower bounds of the allowed Logging Duration during the measurement logging.

Group B Embodiments

11. A method performed by a base station for improving network efficiency, the method comprising:
receiving at least one MDT control and configuration parameter; and
determine at least one MDT configuration.

12. The method of Embodiment 11, further comprising collecting MDT data from at least one UE and/or RAN node.

13. The method of Embodiment 12, further comprising where the REPEAT condition is configured and fulfilled, repeating the MDT data collection from the UE and/or RAN node.

14. The method of Embodiment 13, wherein repeating the MDT data collection comprises assigning a new trace recording session reference and starting the trace recording session of the MDT.

15. The method of Embodiment 13, wherein repeating the MDT data collection comprises reusing a previous trace recording session reference and starting the trace recording session of the MDT

16. The method of Embodiments 12 to 15, further comprising selecting UEs for the MDT data collection.

17. The method of any one of Embodiments 11 to 16, further comprising receiving feedback for re-configurations for MDT and reporting.

18. The method of Embodiment 17, wherein the feedback for re-configurations and reporting indicates that the RAN node should perform re-configurations for MDT and identifies at least one additional requirement, and wherein the method further comprises performing a re-configuration for MDT and generating a new report according to the at least one additional requirement contained in the feedback.

19. The method of any one of Embodiments 11 to 18, wherein the MDT control and configuration parameters contain at least one condition.

20. The method of Embodiment 19, wherein the at least one condition is a REPEAT condition.

21. The method of Embodiment 20, wherein the at least one condition is an associated parameters such as the number of maximum allowed repetitions.

22. The method of any one of Embodiments 20 to 21, wherein the MDT control and configuration parameters comprise a timer specifying a validation duration for the REPEAT condition.

23. The method of any one of Embodiments 11 to 22, wherein the MDT control and configuration parameters contain policies for a RAN node to determine the MDT configurations.

24. The method of any one of Embodiments 11 to 23, wherein the MDT control and configuration parameters comprise at least one of:
List of measurements
Reporting Trigger
Report Interval
Report Amount
Event Threshold
Logging Interval
Logging Duration
Measurement period
Collection period for RRM measurements
Positioning method
Beam-level measurements

25. The method of any one of Embodiments 11 to 24, wherein a policy for determining the MDT configurations is contained in a dedicated message for policies.

26. The method of any one of Embodiments 11 to 25, wherein the MDT control and configuration parameters contain an upper bound or lower bound or both upper and lower bounds of the allowed Logging Interval.

27. The method of any one of Embodiments 11 to 26, wherein the MDT control and configuration parameters contain an indicator to indicate that a RAN node is allowed to determine the Logging Interval according to the upper bound or lower bound or both upper and lower bounds of the allowed Logging Interval.

28. The method of any one of Embodiments 11 to 27, wherein the MDT control and configuration parameters contain an indicator to indicate that UE is allowed to determine the Logging Interval according to the upper bound or lower bound or both upper and lower bounds of the allowed Logging Interval.

29. The method of any one of Embodiments 11 to 28, wherein the MDT control and configuration parameters contain an upper bound or lower bound or both upper and lower bounds of the allowed Logging Duration.

30. The method of Embodiment 29, wherein the MDT control and configuration parameters contain an indicator to indicate that a RAN node is allowed to determine the Logging Interval according to the upper bound or lower bound or both upper and lower bounds of the allowed Logging Duration.

31. The method of Embodiment 29, wherein the MDT control and configuration parameters contain an indicator to indicate that UE is allowed to determine the Logging Interval according to the upper bound or lower bound or both upper and lower bounds of the allowed Logging Duration.

32. The method of any one of Embodiments 11 to 31, wherein the MDT control and configuration parameters contain an upper bound or lower bound or both upper and lower bounds of the allowed Report Interval.

33. The method of any one of Embodiments 11 to 32, wherein the MDT control and configuration parameters contain an upper bound or lower bound or both upper and lower bounds of the allowed Report Amount.

34. The method of any one of Embodiments 11 to 33, wherein the MDT control and configuration parameters contain an upper bound or lower bound or both upper and lower bounds of the allowed Measurement Period.

35. The method of any one of Embodiments 11 to 34, wherein the MDT control and configuration parameters contain an upper bound or lower bound or both upper and lower bounds of the allowed Collection Period.

36. The method of any one of Embodiments 11 to 35, wherein the MDT control and configuration parameters contain beam related parameters for UE to measure and report.

37. The method of Embodiment 36, wherein the parameters include but are not limited to the number of beams above a threshold, a threshold and beam identifiers.

38. The method of any one of Embodiments 36 to 37, wherein the MDT control and configuration parameters contain an upper bound or lower bound or both upper and lower bounds of the allowed number of the beams.

39. The method of any one of Embodiments 11 to 38, wherein the MDT control and configuration parameters contain an upper bound or lower bound or both upper and lower bounds of the allowed parameter related to time interval, period or amount.

40. The method of any one of Embodiments 11 to 39, wherein the MDT control and configuration parameters contain one or more than one indicator(s) to indicate whether the RAN node can determine the corresponding MDT configurations.

41. The method of any one of Embodiments 11 to 40, wherein determining the MDT configurations comprises determining the MDT configurations according to the received policies for the MDT configurations.

42. The method of any one of Embodiments 11 to 41, wherein the MT configurations comprise at least one of:
List of measurements
Reporting Trigger
Report Interval
Report Amount
Event Threshold
Logging Interval
Logging Duration
Measurement period
Collection period for RRM measurements
Positioning method

43. The method of any one of Embodiments 11 to 42, further comprising determining the logging interval according to the configured upper bound or lower bound or both upper and lower bounds of the allowed logging interval.

44. The method of any one of Embodiments 11 to 43, further comprising determining the logging duration according to the configured upper bound or lower bound or both upper and lower bounds of the allowed logging duration.

45. The method of any one of Embodiments 11 to 44, further comprising determining the report interval according to the configured upper bound or lower bound or both upper and lower bounds of the allowed report interval.

46. The method of any one of Embodiments 11 to 45, further comprising determining the report amount according to the configured upper bound or lower bound or both upper and lower bounds of the allowed report amount.

47. The method of any one of Embodiments 11 to 46, further comprising for Immediate MDT, determining the Measurement Period according to the configured upper bound or lower bound or both upper and lower bounds of the allowed Measurement Period.

48. The method of any one of Embodiments 11 to 47, further comprising for Immediate MDT, the RAN node determines the Collection Period according to the configured upper bound or lower bound or both upper and lower bounds of the allowed Collection Period.

49. The method of any one of Embodiments 11 to 48, further comprising for Logged MDT, determining RRC state specific parameters for selected UEs in RRC_IDLE and UEs in RRC_INACTIVE respectively.

50. The method of any one of Embodiments 11 to 49, further comprising determining beam related parameters for UE to measure and report. The parameters include but not limited to the number of beams above a threshold, a threshold and beam identifiers.

Group C Embodiments

51. A wireless device for improving network efficiency, the wireless device comprising:
processing circuitry configured to perform any of the steps of any of the Group A embodiments; and
power supply circuitry configured to supply power to the wireless device.

52. A base station for improving network efficiency, the base station comprising:
processing circuitry configured to perform any of the steps of any of the Group B embodiments;
power supply circuitry configured to supply power to the wireless device.

53. A user equipment (UE) for improving network efficiency, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

54. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

55. The communication system of the pervious embodiment further including the base station.

56. The communication system of the previous 2 embodiments, further including the UE, wherein the UE is configured to communicate with the base station.

57. The communication system of the previous 3 embodiments, wherein:
the processing circuitry of the host computer is configured to execute a host application, thereby providing the user data; and
the UE comprises processing circuitry configured to execute a client application associated with the host application.

58. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

59. The method of the previous embodiment, further comprising, at the base station, transmitting the user data.

60. The method of the previous 2 embodiments, wherein the user data is provided at the host computer by executing a host application, the method further comprising, at the UE, executing a client application associated with the host application.

61. A user equipment (UE) configured to communicate with a base station, the UE comprising a radio interface and processing circuitry configured to performs the of the previous 3 embodiments.

62. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

63. The communication system of the previous embodiment, wherein the cellular network further includes a base station configured to communicate with the UE.

64. The communication system of the previous 2 embodiments, wherein:
the processing circuitry of the host computer is configured to execute a host application, thereby providing the user data; and
the UE's processing circuitry is configured to execute a client application associated with the host application.

65. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

66. The method of the previous embodiment, further comprising at the UE, receiving the user data from the base station.

67. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

68. The communication system of the previous embodiment, further including the UE.

69. The communication system of the previous 2 embodiments, further including the base station, wherein the base station comprises a radio interface configured to communicate with the UE and a communication interface configured to forward to the host computer the user data carried by a transmission from the UE to the base station.

70. The communication system of the previous 3 embodiments, wherein:
the processing circuitry of the host computer is configured to execute a host application; and
the UE's processing circuitry is configured to execute a client application associated with the host application, thereby providing the user data.

71. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

72. A method implemented in a communication system including a host computer, a base station and a user equipment (UE), the method comprising:
at the host computer, receiving user data transmitted to the base station from the UE, wherein the UE performs any of the steps of any of the Group A embodiments.

73. The method of the previous embodiment, further comprising, at the UE, providing the user data to the base station.

74. The method of the previous 2 embodiments, further comprising:
at the UE, executing a client application, thereby providing the user data to be transmitted; and
at the host computer, executing a host application associated with the client application.

75. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

76. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

77. The communication system of the previous embodiment further including the base station.

78. The communication system of the previous 2 embodiments, further including the UE, wherein the UE is configured to communicate with the base station.

79. The communication system of the previous 3 embodiments, wherein:
the processing circuitry of the host computer is configured to execute a host application;
the UE is configured to execute a client application associated with the host application, thereby providing the user data to be received by the host computer.

80. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments. 81. The method of the previous embodiment, further comprising at the base station, receiving the user data from the UE.

88. The method of the previous 2 embodiments, further comprising at the base station, initiating a transmission of the received user data to the host computer. Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

Explanations are provided below for various abbreviations/acronyms used in the present disclosure. If there is an inconsistency between abbreviations, preference should be given to how it is used above. If listed multiple times below, the first listing should be preferred over any subsequent listing(s).

1× RTT CDMA2000 1× Radio Transmission Technology

3GPP 3rd Generation Partnership Project

5G 5th Generation

5GS 5G System

5QI 5G QoS Identifier

ABS Almost Blank Subframe

AN Access Network

AN Access Node

ARQ Automatic Repeat Request

AS Access Stratum

AWGN Additive White Gaussian Noise

BCCH Broadcast Control Channel

BCH Broadcast Channel

CA Carrier Aggregation

CC Carrier Component

CCCH SDU Common Control Channel SDU

CDMA Code Division Multiplexing Access

CGI Cell Global Identifier

CIR Channel Impulse Response

CN Core Network

CP Cyclic Prefix

CPICH Common Pilot Channel

CPICH Ec/No CPICH Received energy per chip divided by the power density in the band

CQI Channel Quality information

C-RNTI Cell RNTI

CSI Channel State Information

DCCH Dedicated Control Channel

DL Downlink

DM Demodulation

DMRS Demodulation Reference Signal

DRX Discontinuous Reception

DTX Discontinuous Transmission

DTCH Dedicated Traffic Channel

DUT Device Under Test

E-CID Enhanced Cell-ID (positioning method)

E-SMLC Evolved-Serving Mobile Location Centre

ECGI Evolved CGI

eMBB Enhanced Mobile BroadBand

eNB E-UTRAN NodeB

ePDCCH enhanced Physical Downlink Control Channel

EPS Evolved Packet System

E-SMLC evolved Serving Mobile Location Center

E-UTRA Evolved UTRA

E-UTRAN Evolved Universal Terrestrial Radio Access Network

FDD Frequency Division Duplex

FFS For Further Study

GERAN GSM EDGE Radio Access Network

gNB gNode B (a base station in NR; a Node B supporting NR and connectivity to NGC)

GNSS Global Navigation Satellite System

GSM Global System for Mobile communication

HARQ Hybrid Automatic Repeat Request

HO Handover

HSPA High Speed Packet Access

HRPD High Rate Packet Data

LOS Line of Sight

LPP LTE Positioning Protocol

LTE Long-Term Evolution

MAC Medium Access Control

MBMS Multimedia Broadcast Multicast Services

MBSFN Multimedia Broadcast multicast service Single Frequency Network

MBSFN ABS MBSFN Almost Blank Subframe

MDT Minimization of Drive Tests

MIB Master Information Block

MME Mobility Management Entity

MSC Mobile Switching Center

NGC Next Generation Core

NG-RAN node Either a gNB or an ng-eNB

NPDCCH Narrowband Physical Downlink Control Channel

NR New Radio

OAM Operations, Administration and Maintenance

OCNG OFDMA Channel Noise Generator

OFDM Orthogonal Frequency Division Multiplexing

OFDMA Orthogonal Frequency Division Multiple Access

ONAP Open Networking Automation Platform

OSS Operations Support System

OTDOA Observed Time Difference of Arrival

O&M Operation and Maintenance

PBCH Physical Broadcast Channel

P-CCPCH Primary Common Control Physical Channel

PCell Primary Cell

PCFICH Physical Control Format Indicator Channel

PDCCH Physical Downlink Control Channel

PDP Profile Delay Profile

PDSCH Physical Downlink Shared Channel

PGW Packet Gateway

PHICH Physical Hybrid-ARQ Indicator Channel

PLMN Public Land Mobile Network

PMI Precoder Matrix Indicator

PRACH Physical Random Access Channel

PRS Positioning Reference Signal

PS Packet Switched

PSS Primary Synchronization Signal

PUCCH Physical Uplink Control Channel

PUSCH Physical Uplink Shared Channel

RACH Random Access Channel

QAM Quadrature Amplitude Modulation

RAB Radio Access Bearer

RAN Radio Access Network

RANAP Radio Access Network Application Part

RAN node An eNB or NG-RAN node (either a gNB or ng-eNB)

RAT Radio Access Technology

RLM Radio Link Management

RNC Radio Network Controller

RNTI Radio Network Temporary Identifier

RRC Radio Resource Control

RRM Radio Resource Management

RS Reference Signal

RSCP Received Signal Code Power

RSRP Reference Symbol Received Power OR

Reference Signal Received Power

RSRQ Reference Signal Received Quality OR Reference Symbol Received Quality

RSSI Received Signal Strength Indicator

RSTD Reference Signal Time Difference

RWR Release with Redirect

SCH Synchronization Channel

SCell Secondary Cell

SCS Subcarrier Spacing

SDU Service Data Unit

SFN System Frame Number

SGW Serving Gateway

SI System Information

SIB System Information Block

SNR Signal to Noise Ratio

S-NSSAI Single Network Slice Selection Assistance Information

SON Self Optimized Network

SS Synchronization Signal

SSS Secondary Synchronization Signal

TBS Transport Block Size

TDD Time Division Duplex

TDOA Time Difference of Arrival

TOA Time of Arrival

TSS Tertiary Synchronization Signal

TTI Transmission Time Interval

UE User Equipment

UL Uplink

UMTS Universal Mobile Telecommunication System

USIM Universal Subscriber Identity Module

UTDOA Uplink Time Difference of Arrival

UTRA Universal Terrestrial Radio Access

UTRAN Universal Terrestrial Radio Access Network

WCDMA Wide CDMA

WLAN Wide Local Area Network

1. A method performed by a user equipment, UE, the method comprising:
receiving at least one Minimization of Drive Test, MDT, control and configuration parameter, the at least one MDT control and configuration parameter containing an upper bound or a lower bound or both upper and lower bounds of at least one of an allowed Logging Interval and an allowed Logging Duration; and
determining at least one MDT configuration.

2. The method of claim 1, wherein the at least one MDT configuration is determined based on the at least one MDT control and configuration parameter.

3. The method of claim 1, wherein after determining the at least one MDT configuration, the UE starts measurement logging when it is in RRC_IDLE state or in RRC_INACTIVE state.

4-7. (canceled)

8. A method performed by a base station, the method comprising:
receiving at least one Minimization of Drive Test, MDT, control and configuration parameter, the at least one MDT control and configuration parameter containing an upper bound or a lower bound or both upper and lower bounds of at least one of an allowed Logging Interval and an allowed Logging Duration; and
determining at least one MDT configuration.

9. The method of claim 8, further comprising collecting MDT data from at least one user equipment, UE.

10. (canceled)

11. The method of claim 8, wherein the at least one MDT control and configuration parameter contains an indicator to indicate that a Radio Access Network, RAN, node is allowed to determine the Logging Interval according to the upper bound or lower bound or both upper and lower bounds of the allowed Logging Interval.

12-14. (canceled)

15. A user equipment, UE, comprising:
processing circuitry configured to:
receive at least one Minimization of Drive Test, MDT, control and configuration parameter, the at least one MDT control and configuration parameter containing an upper bound or a lower bound or both upper and lower bounds of at least one of an allowed Logging Interval and an allowed Logging Duration; and
determine at least one MDT configuration.

16. The UE of claim 16, wherein the at least one MDT configuration is determined based on the at least one MDT control and configuration parameter.

17. The UE of claim 15, wherein the processing circuitry is configured to, after determining the at least one MDT configuration, start measurement logging when the UE is in RRC_IDLE state or in RRC_INACTIVE state.

18. The UE of claim 17, wherein the processing circuitry is configured to determine a Logging Interval according to the configured upper bound or lower bound or both upper and lower bounds of the allowed Logging Interval before starting the measurement logging.

19. The UE of claim 17, wherein the processing circuitry is configured to determine a Logging Interval according to the configured upper bound or lower bound or both upper and lower bounds of the allowed Logging Interval during the measurement logging.

20. The UE of claim 17, wherein the processing circuitry is configured to determine a Logging Duration according to the configured upper bound or lower bound or both upper and lower bounds of the allowed Logging Duration before starting the measurement logging.

21. The UE of claim 17, wherein the processing circuitry is configured to determine a Logging Duration according to the configured upper bound or lower bound or both upper and lower bounds of the allowed Logging Duration during the measurement logging.

22. A base station comprising:
processing circuitry configured to:
receive at least one Minimization of Drive Test, MDT, control and configuration parameter, the at least one MDT control and configuration parameter containing an upper bound or a lower bound or both upper and lower bounds of at least one of an allowed Logging Interval and an allowed Logging Duration; and
determine at least one MDT configuration.

23. The base station of claim 22, further comprising collecting MDT data from at least one user equipment.

24. The base station of claim 22 wherein the at least one MDT control and configuration parameter contains policies for a Radio Access Network, RAN, node to determine the at least one MDT configuration.

25. The base station of claim 22, wherein the at least one MDT control and configuration parameter contains an indicator to indicate that a RAN node is allowed to determine the Logging Interval according to the upper bound or lower bound or both upper and lower bounds of the allowed Logging Interval.

26. The base station of claim 22, wherein the at least one MDT control and configuration parameter contains an indicator to indicate that a RAN node is allowed to determine the Logging Duration according to the upper bound or lower bound or both upper and lower bounds of the allowed Logging Duration.

27. The base station of claim 22, wherein the processing circuitry is configured to determine the logging interval according to the configured upper bound or lower bound or both upper and lower bounds of the allowed logging interval.

28. The base station of claim 22, wherein the processing circuitry is configured to determine the logging duration according to the configured upper bound or lower bound or both upper and lower bounds of the allowed logging duration.

29-30. (canceled)
